(19) United States
(12) Patent Application Publication
(10) Pub. No.: US 2023/0249805 A1
(43) Pub. Date: Aug. 10, 2023

(54) AIRCRAFT COMPRISING AT LEAST ONE FLUIDIC PROPULSION DEVICE INTEGRATED INTO AN AIRFRAME ELEMENT AND METHOD OF USE

(71) Applicant: SAFRAN NACELLES, Gonfreville-l'Orcher (FR)

(72) Inventors: Solène Valleroy, Moissy-Cramayel (FR); Laurent Georges Valleroy, Moissy-Cramayel (FR)

(21) Appl. No.: 18/165,253

(22) Filed: Feb. 6, 2023

(30) Foreign Application Priority Data
Feb. 7, 2022 (FR) 2201033

(51) Int. Cl. B64C 21/01

(52) U.S. Cl. CPC B64C 21/01

(57) ABSTRACT

An aircraft having an airframe with several airframe elements and at least one fluidic propulsion device with a peripheral nozzle defining an internal cavity in which an external airflow circulates, the peripheral nozzle having openings configured to inject a plurality of high-speed airflows into the internal cavity so as to accelerate the external airflow in an upstream to downstream manner. A portion of the peripheral nozzle can be integrated into an airframe element so as to enable acceleration of an external airflow circulating from upstream to downstream on said airframe element so as to improve its re-adhesion to said airframe element.

### TECHNICAL FIELD

The present invention relates to the field of propulsion of an aircraft.

In a known way, an aircraft comprises several propulsion devices comprising a rotating propelling member such as a turbojet blower or turboprop engine propeller in order to accelerate an airflow circulating from upstream to downstream.

During flight of the aircraft, an airflow circulates from upstream to downstream along airframe elements of the aircraft such as a wing, a tail unit or a nacelle of a turbomachine, which generally induces turbulence that increases drag and/or affects lift. In order to eliminate this drawback, it was proposed to modify the faired surface (adding ribs, etc.) to enable optimal re-adhesion of the boundary layer and improve lift.

These various solutions are unsatisfactory and it is an objective of the present invention to improve re-adhesion of the boundary layer of faired surfaces.

Incidentally, in order to avoid damaging a rotating propelling member and degrading the operation of a propulsion device upon ingestion of foreign objects, it was proposed to use a fluidic propulsion device to accelerate an airflow circulating from upstream to downstream by injecting a high-speed airflow peripherally. A fluidic propulsion device does not require a rotating propelling member and is therefore not likely to be damaged in case of ingestion, which is advantageous.

In order to obtain optimal propulsion, it was proposed to mount a fluidic propulsion device to an aircraft fuselage via a support arm/pylon in order to accelerate an upstream airflow undisturbed by the fuselage.

### SUMMARY

The invention relates to an aircraft comprising an airframe and several airframe elements and at least one fluidic propulsion device configured to accelerate an external airflow circulating from upstream to downstream, the fluidic propulsion device comprising a peripheral nozzle defining an internal cavity, free of obstacles, in which the external airflow circulates, the peripheral nozzle comprising openings configured to inject a plurality of high-speed airflows into the internal cavity so as to accelerate the external airflow upstream to downstream.

The aircraft is remarkable in that a portion of the peripheral nozzle is incorporated into an airframe element so as to enable the acceleration of an external airflow circulating from upstream to downstream on said airframe element so as to improve its re-adhesion to said airframe element.

By means of the invention, one or more fluidic propulsion devices can be used to enable local re-adhesion of the boundary layer that undergoes turbulence in the vicinity of an airframe element. Resistance to forward motion (drag), lift and propulsion are improved. Advantageously, the risk of damage is low since a fluidic propulsion device has no rotating propelling member.

Furthermore, the present invention makes it possible to counteract a prejudice of prior art which aimed to systematically offset a fluidic propulsion device from an airframe element (wing, fuselage, etc.) in order not to be disturbed by turbulence in the vicinity of an airframe element.

Preferably, the internal cavity of the fluidic propulsion device is partially delimited by a surface of said airframe element. Thus, the boundary layer at the aerodynamic structure of said airframe element makes it possible to capture the boundary layer optimally to promote its re-adhesion.

Preferably, said airframe element defines an under-wing lower surface and an over-wing upper surface. The fluidic propulsion device is mounted to the over-wing upper surface. This makes it possible to improve the lift or even the efficiency of the high-lift devices and/or flight controls.

According to one aspect of the invention, the airframe element is selected from a wing, a tail unit, or a turbomachine nacelle. Integration into a nacelle makes it possible to take advantage of high-speed airflow from the turbomachine.

Preferably, the fluidic propulsion device extends as a vertical protrusion from said airframe element. According to one preferred aspect, the fluidic propulsion device has a flattened shape to promote capture of the external airflow circulating from upstream to downstream on said airframe element. This makes it possible to capture the boundary layer optimally to promote its re-adhesion.

Preferably, the fluidic propulsion device is supplied with a high-speed airflow by a supply system, in particular by a compression system of the aircraft. According to one preferred aspect, the supply system is a conventional propulsion device comprising a rotating propelling member. Thus, the fluidic propulsion device provides an additional propulsion to a conventional propulsion device.

Preferably, the supply system is configured to bleed off an external airflow upstream of the fluidic propulsion device to accelerate it into a high-speed airflow. Such upstream air bleed promotes re-adhesion of the boundary layer and thus improves lift.

According to one aspect of the invention, the supply system comprises a plurality of scoop openings, on said airframe element, which are configured to bleed off an external airflow upstream of the fluidic propulsion device to accelerate it into a high-speed airflow. Preferably, the airframe element comprises a porous skin to capture the external airflow over a large surface area to promote re-adhesion without inducing turbulence.

The invention also relates to a method of use of an aircraft as set forth previously comprising at least one fluidic propulsion device, a portion of the peripheral nozzle of which is integrated into an airframe element, the method comprising at least one step of injecting a plurality of high-speed airflows into the internal cavity of the fluidic propulsion device so as to accelerate the external airflow circulating from upstream to downstream on said airframe element.

### BRIEF DESCRIPTION OF THE DRAWINGS

The invention will be better understood upon reading the following description, given as an example, and by referring to the following figures, given as non-limiting examples, in which identical references are given to similar objects.

FIG. 1 is a schematic partial representation of an aircraft comprising a plurality of fluidic propulsion devices integrated into elements of the wing and horizontal tail unit.

FIG. 2 is a schematic representation viewed from upstream of a fluidic propulsion device.

FIG. 3 is a schematic axial cross-sectional representation of the integration of the fluidic propulsion device integrated into a wing.

FIG. 4 is a schematic top representation of the fluidic propulsion device.

FIG. 5 is a schematic axial cross-sectional representation of the integration of the fluidic propulsion device integrated into a wing according to a second embodiment.

It should be noted that the figures set out the invention in detail in order to implement the invention, said figures can of course be used to better define the invention if necessary.

### DETAILED DESCRIPTION

With reference to FIG. 1, the invention relates to an aircraft 100, in particular to an airplane but the invention applies to other types of aircraft, such as to a helicopter or a drone.

In a known way, the aircraft 100 comprises an airframe comprising several airframe elements, for example, a nose cone, a main box, wings 101 and a tail unit 102. The airframe elements also comprise a nacelle 103 of a propelling turbomachine 2. In this example, the airframe elements are in contact with the external airflow F1 circulating from upstream to downstream along a longitudinal axis X directed downstream to upstream.

Still with reference to FIG. 1, the aircraft 100 comprises several fluidic propulsion devices 3 distributed over the aircraft 100. In an exemplary embodiment, the plurality of fluidic propulsion devices 3 are symmetrically distributed over the aircraft 100. In the embodiment shown, fluidic propulsion devices 3 are integrated into a wing 101, a tail unit 102, a nacelle 103, and a fuselage 104, but of course fluidic propulsion devices 3 may only be present on certain airframe elements. Similarly, one or more fluidic propulsion devices 3 may be mounted to the same airframe element in order to enable optimal re-adhesion of the external airflow as will be set forth hereafter depending on the geometry and positioning of the airframe element 101, 102, 103, 104. According to one aspect of the invention, the wing 101 may also have a rhomboidal shape.

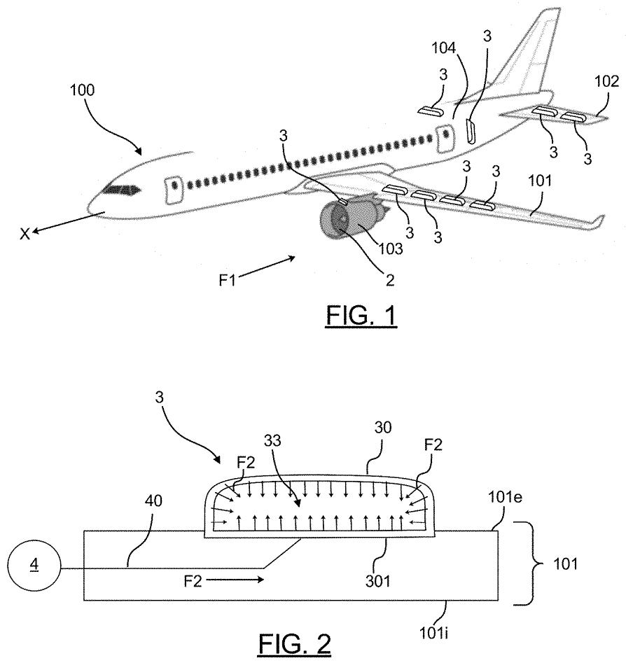

A fluidic propulsion device 3 integrated into a wing 101 will henceforth be set forth with reference to FIGS. 2 to 4. Nevertheless, it goes without saying that the invention applies analogously to any airframe element, a tail unit 102, a nacelle 103, a fuselage 104 or to another airframe element of the aircraft such as the rear part of the fuselage, aerodynamic growths of a helicopter such as mini wings.

In this example, the wing 101 extends laterally of the fuselage and comprises an under-wing lower surface 101i and an over-wing upper surface 101e, which are in contact with the external airflow F1 circulating from upstream to downstream along a longitudinal axis X. The external airflow F1 is likely to break away from the over-wing upper surface 101e depending on the operating conditions, which affects the lift of the wing 101 and limits the propulsion performance. In practice, break away occurs at the external airflow layer F1 which is closest to the wing 101 and whose speed is low. This layer is called the “boundary layer”. The same applies to all aerodynamic surfaces.

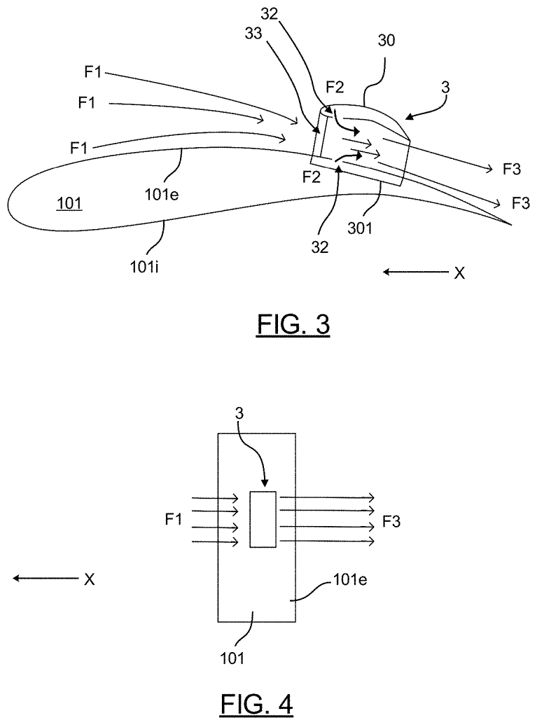

With reference to FIG. 2, the fluidic propulsion device 3 comprises a peripheral nozzle 30 defining an internal cavity 33, free of obstacles, in which the external airflow F1 circulates as illustrated in FIG. 3. The internal cavity 33 extends longitudinally along the axis X and is free of obstacles, enabling a foreign object to be ingested during flight of the aircraft 100 without risk of damage. In other words, the fluidic propulsion device 3 consists of a peripheral nozzle 30.

With reference to FIG. 2, the peripheral nozzle 30 has a hollow structure connected to a supply system 4 enabling a high-pressure airflow F2 to be provided, which will be set forth hereafter. As shown, the peripheral nozzle 30 has a wall or structure that, when combined with the surface of the wing 101, defines a hollow structure having an upstream opening to the peripheral nozzle 30 and a downstream opening at the downstream end of the peripheral nozzle 30.

With reference to FIG. 3, the peripheral nozzle 30 comprises openings 32 configured to inject a plurality of high-speed airflows F2 into the internal cavity 33 so as to accelerate the external airflow F1 from upstream to downstream. In other words, the external airflow F1 is considered to be a low-speed flow compared to the high-speed airflow F2. The external airflow F1 and the high-speed airflow F2 are guided longitudinally into the internal cavity 33 of the peripheral nozzle 30 so as to obtain at the outlet an accelerated airflow F3 which improves re-adhesion while participating in propulsion as illustrated in FIG. 4. Airflow speed F3 can be larger or faster than airflow speed F1, at the upstream opening to the peripheral nozzle.

The openings 32, such as for airflow injection F2, are formed on an internal wall of the peripheral nozzle 30 so as to enable injection towards the internal cavity 33. Preferably, the openings 32 are positioned in an upstream part of the peripheral nozzle 30 in order to be able to guide longitudinally downstream the external airflow F1 and the high-speed airflow F2 into the internal cavity 33. The incidence of the openings 32 is adapted to enable an optimal acceleration while limiting turbulence. For example, a tangential or substantially tangential incidence is adapted. An angular deviation of less than 20° from the tangential direction is recommended.

The openings 32 can be in various forms, such as drilled holes, slots or similar. The openings 32 are preferably distributed peripherally to ensure a homogeneous acceleration of the airflow captured by the peripheral nozzle 30. The openings 32 can optionally have tips or other shaped features to guide the discharged high speed airflow.

According to the invention, a portion of the peripheral nozzle 30 is integrated into the wing 101 so as to enable acceleration of an external airflow F1 circulating from upstream to downstream on said wing 101 so as to improve its re-adhesion to said wing 101.

In other words, this enables the external airflow F1 in contact with the fender 101 to be captured, which is likely, depending on the flight configuration, to break away by increasing the drag and/or decreasing the lift to accelerate it in order, on the one hand, to re-adhere it and, on the other hand, to participate in propulsion. Said differently, as external airflow F1 separates from the upper surface of the wing 101, the peripheral nozzle 30 in accordance with aspects of the invention can impart high speed airflow F2 in the area of the peripheral nozzle 30 to increase the external airflow F1, which has the effect causing the external airflow to re-adhere to the surface of the wing, which helps lift and propulsion.

In this example, the fluidic propulsion device 3 is mounted to the over-wing upper surface 101e. Thus, as illustrated in FIGS. 2 and 3, the internal cavity 33 of the fluidic propulsion device 3 is partially delimited by the over-wing upper surface 101e of said wing 101. Thus, the external airflow F1 captured by the fluidic propulsion device 3 is that which was guided by the over-wing upper surface 101e and which has a low speed.

The lower part of the peripheral nozzle 30 is therefore adapted to the shape of the over-wing upper surface 101e in order to be integrated into the latter. The upper part of the peripheral nozzle 30, which protrudes from the over-wing upper surface 101e, preferably has a flattened shape so as to reduce drag as much as possible. For the peripheral nozzle 30, a transverse cross-section with respect to the longitudinal axis X is defined, which comprises a length extending in parallel to the surface of the airframe element and a height extending perpendicularly to said length. By flattened shape, it is meant a peripheral nozzle 30 whose transverse cross-section comprises a length larger than its height, preferably at least 2 times larger. The peripheral nozzle 30 thus mainly captures the layer of the external airflow F1 which is close to the wing 101.

The hollow wall of the peripheral nozzle 30 has a thickness which is calibrated so as to enable sufficient supply of the openings 32 while limiting drag. The over-wing upper surface 101 of the wing 101 thus comprises a cavity 301 for supplying high-speed airflow F2 which comprises openings 32 to inject high-speed airflows F2 into the internal cavity 33.

The peripheral nozzle 30 is supplied with high-speed air F2 via a supply system 4 of the aircraft 100 which may be in various forms. Preferably, the aircraft 100 comprises a compressor which bleeds off an external airflow F1 to accelerate it and supply the peripheral nozzle 30. Preferably, when the aircraft comprises a propulsion device comprising a rotating propelling member, hereinafter referred to as “conventional propulsion device 2”, the latter can be adapted to perform the function of supplying high-speed airflow F2.

With reference to FIG. 2, the supply system 4 can be connected to the peripheral nozzle 30 by a pneumatic circuit 40 whose length is optimized to limit its mass. The use of a conventional propulsion device 2 as a supply system 4 enables one or more fluidic propulsion devices 3 to be positioned in proximity to a conventional propulsion device 2 while limiting the length of the pneumatic circuit 40. In the case of a nacelle 103 enclosing a conventional propulsion device 2 and fitted with a fluid propulsion device 3, the length of the pneumatic circuit 40 can be short.

Preferably, the conventional propulsion device 2 may be in the form of a turbomachine (turbine jet, turboprop engine, etc.), an electric motor or other.

According to a preferred aspect, the supply system 4 is configured to bleed off an external airflow F1 at the airframe element 101, 102, 103, in particular upstream of the fluidic propulsion device 3.

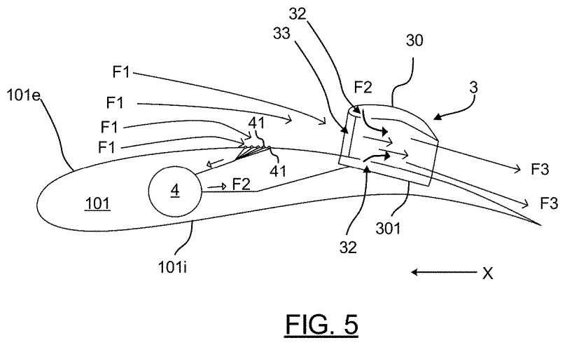

According to one embodiment, with reference to FIG. 5, the supply system 4 comprises at least one scoop opening 41 formed in the over-wing upper surface 101e longitudinally aligned with the fluidic propulsion device 3 so as to suck in the external airflow F1 upstream of the fluidic propulsion device 3 and limit break away. This configuration is aerodynamically advantageous and improves lift. According to one preferred aspect, the over-wing upper surface 101e comprises a plurality of scoop openings 41 so as to form a porous skin upstream of the fluidic propulsion device 3 as illustrated in FIG. 5. The supply system 4 thus enables an external airflow F1 to be sucked in to inject it into the fluidic propulsion device 3 after acceleration.

According to one aspect of the invention, the aircraft 100 comprises, on the one hand, at least one propulsion device comprising a rotating propelling member, hereinafter referred to as “conventional propulsion device 2”, to ensure propulsion of the aircraft 100 and, on the other hand, at least one fluidic propulsion device 3 for local re-adhesion of the external airflow F1 to an airframe element 101, 102, 103, 104 while enabling participation in propulsion. Thus, according to this aspect of the invention, the fluidic propulsion device(s) 3 provide an additional propulsion in parallel to the conventional propulsion device(s) 2.

The conventional propulsion device 2 may be in the form of a turbomachine connected to a wing, a power generator mounted at the rear of the fuselage, a power generator mounted at the root of a wing or other.

In such a case, the high-speed airflow F2 of the fluidic propulsion device(s) 3 may be provided directly by one or more conventional propulsion devices 2 which thereby fulfill the role of the supply system 4. It goes without saying that the system 4 for supplying high-speed airflow F2 can also be independent of the conventional propulsion device(s) 2.

According to another aspect of the invention, the aircraft 100 comprises only one or more fluidic propulsion devices 3 to enable local re-adhesion of the external airflow F1 to an airframe element 101, 102, 103, 104 and to enable propulsion. Thus, according to this aspect of the invention, the fluidic propulsion device(s) 3 alone ensure propulsion.

A method of use of an aircraft 100 will henceforth be set forth with reference to FIG. 2. The method of use comprises at least one step of injecting a plurality of high-speed airflows F2 into the internal cavity 33 of the fluidic propulsion device 3 so as to accelerate the external airflow F1 circulating from upstream to downstream on said airframe element 101 so as to obtain an accelerated airflow F3 which is re-adhered and contributes to the reduction of drag and/or lift and to propulsion.

Preferably, the method also comprises a step of bleeding off an external airflow F1 upstream of the fluidic propulsion device 3, in particular, through a porous wall of the airframe element 101. Preferably, the high-speed airflow F2 is obtained by accelerating the external airflow F1 by the conventional propulsion device 2.

By means of the invention, turbulence at the elements of the airframe is reduced locally through the use of a plurality of fluidic propulsion devices 3 which improve lift and participate in propulsion. The invention has been set forth for an aircraft with a pilot but the invention also applies to an unmanned aircraft called a “drone”.

1. An aircraft comprising an airframe comprising several airframe elements and at least one fluidic propulsion device configured to accelerate an external airflow circulating from upstream to downstream, the fluidic propulsion device comprising a peripheral nozzle defining an internal cavity, free of obstacles, in which the external airflow circulates, the peripheral nozzle comprising openings configured to inject a plurality of high-speed airflows into the internal cavity so as to accelerate the external airflow upstream to downstream, a portion of the peripheral nozzle being integrated into an airframe element so as to enable acceleration of an external airflow circulating from upstream to downstream on said airframe element so as to improve its re-adhesion to said airframe element, the fluidic propulsion device being supplied with a high-speed airflow by a supply system, the supply system comprising a plurality of scoop openings on said airframe element configured to bleed off an external airflow upstream of the fluidic propulsion device to accelerate it into a high-speed airflow.

2. The aircraft according to claim 1, wherein the internal cavity of the fluidic propulsion device is partially delimited by a surface of said airframe.

3. The aircraft according to claim 1, wherein said airframe element defines an under-wing lower surface and an over-wing upper surface, the fluidic propulsion device is mounted to the over-wing upper surface.

4. The aircraft according to claim 1, wherein the airframe element is selected from a wing, a tail unit, or a turbomachine nacelle.

5. The aircraft according to claim 1, wherein the fluidic propulsion device extends vertically protruding from said airframe element.

6. The aircraft according to claim 1, wherein the fluidic propulsion device has a flattened shape to promote capture of the external airflow circulating from upstream to downstream on said airframe element.

7. The aircraft according to claim 1, wherein the fluidic propulsion device is supplied by a compression system of the aircraft.

8. A method of use of the aircraft according to claim 1 comprising at least one fluidic propulsion device, a portion of the peripheral nozzle of which is integrated into an airframe element, the method comprising a step of injecting a plurality of high-speed airflows into the internal cavity of the fluidic propulsion device so as to accelerate the external airflow flowing from upstream to downstream on said airframe element.
